(19) United States
(12) Patent Application Publication
(10) Pub. No.: US 2026/0133783 A1
(43) Pub. Date: May 14, 2026

(54) APPLICATION FAST LOADING METHOD AND APPARATUS, ELECTRONIC DEVICE AND STORAGE MEDIUM

(71) Applicant: Beijing Zitiao Network Technology Co., Ltd., Beijing (CN)

(72) Inventors: Canbiao Mai, Beijing (CN); Dongfeng Xie, Beijing (CN); Wenxuan Zhang, Beijing (CN)

(21) Appl. No.: 19/390,071

(22) Filed: Nov. 14, 2025

(30) Foreign Application Priority Data
Nov. 14, 2024 (CN) 202411630657.6

(51) Int. Cl. G06F 8/61; G06F 9/4401

(52) U.S. Cl. CPC G06F 8/61; G06F 9/4416

(57) ABSTRACT

The embodiment of the present disclosure provides an application fast loading method and apparatus, an electronic device and a storage medium, comprising: downloading a bootstrap program of a second application from a server in a first application in response to a loading operation for the second application and based on an installation authority of the first application; by automatically executing the bootstrap program, downloading a target program package of the second application while displaying a loading interface of the second application, where the target program package includes an executive program and program resources required by running the second application; and triggering the second application to start by restarting the bootstrap program, after downloading of the target program package of the second application is completed.

### CROSS-REFERENCE TO RELATED APPLICATIONS

The present application is based on and claims the benefit of the priority to the Chinese application No. 202411630657.6 filed on November 14, 2024, the disclosure of which is incorporated herein in its entirety.

### TECHNICAL FIELD

Embodiments of the present disclosure relate to the technical field of Internet, in particular to an application fast loading method and apparatus, an electronic device and a storage medium.

### BACKGROUND

Currently, a network platform guides a user to download an external application (APP) by presenting the application in a specific location, so as to achieve the purpose of application popularization.

In the related art, after a user clicks a Download link of an application in a network platform by operating a terminal device, the terminal device downloads an installation package of the application through a browser, and after the installation package is downloaded, the user triggers installation and operation of the application.

### SUMMARY

The embodiments of the present disclosure provide an application fast loading method and apparatus, an electronic device and a storage medium.

In a first aspect, an embodiment of the present disclosure provides an application fast loading method, including:

downloading a bootstrap program of a second application from a server in a first application in response to a loading operation for the second application and based on an installation authority of the first application;

by automatically executing the bootstrap program, downloading a target program package of the second application while displaying a loading interface of the second application, where the target program package includes an executive program and program resources required by running the second application; and

triggering the second application to start by restarting the bootstrap program, after downloading of the target program package of the second application is completed.

In a second aspect, an embodiment of the present disclosure provides an application fast loading apparatus, including:

an interacting unit configured to, download a bootstrap program of a second application from a server in a first application in response to a loading operation for the second application and based on an installation authority of the first application;

a processing unit configured to, by automatically executing the bootstrap program, download a target program package of the second application while displaying a loading interface of the second application, where the target program package includes an executive program and program resources required by running the second application; and

a starting unit configured to, trigger the second application to start by restarting the bootstrap program, after downloading of the target program package of the second application is completed.

In a third aspect, an embodiment of the present disclosure provides an electronic device, including: a processor and a memory; where

the memory stores computer-executable instructions;

the processor executes the computer-executable instructions stored by the memory, to cause the at least one processor to perform the application fast loading method as described above in the first aspect and in various possible designs of the first aspect.

In a fourth aspect, an embodiment of the present disclosure provides a computer-readable storage medium having stored thereon computer-executable instructions, which when executed by a processor, implement the application fast loading method as described above in the first aspect and in various possible designs of the first aspect.

In a fifth aspect, an embodiment of the present disclosure provides a computer program product including a computer program which, when executed by a processor, implements the application fast loading method as described above in the first aspect and in various possible designs of the first aspect.

### BRIEF DESCRIPTION OF THE DRAWINGS

In order to more clearly illustrate the technical solutions in the embodiments of the present disclosure or in the related art, the drawings used in the description of the embodiments or the related art will be briefly described below, and it is obvious that the drawings in the following description are some embodiments of the present disclosure, and those skilled in the art can obtain other drawings without creative labor.

FIG. 1 is an application scenario diagram of an application fast loading method according to an embodiment of the present disclosure;

FIG. 2 is a first flow diagram of an application fast loading method according to an embodiment of the present disclosure;

FIG. 3 is a schematic diagram of an operation process of a terminal device when the terminal device automatically executes based on a bootstrap program, according to an embodiment of the present disclosure;

FIG. 4 is a schematic display diagram of a display interface of a terminal device corresponding to a second application fast loading process, according to an embodiment of the present disclosure;

FIG. 5 is a schematic flow diagram of a second application fast loading method according to an embodiment of the present disclosure;

FIG. 6 is a schematic diagram of signaling interaction based on calling a running module and an updating module according to an embodiment of the present disclosure;

FIG. 7 is a schematic diagram of signaling interaction when a second application is started according to an embodiment of the present disclosure;

FIG. 8 is a schematic diagram of a process of fast loading a second application according to an embodiment of the present disclosure;

FIG. 9 is a block diagram of an application fast loading apparatus according to an embodiment of the present disclosure;

FIG. 10 is a schematic structural diagram of an electronic device according to an embodiment of the present disclosure;

FIG. 11 is a schematic hardware structure diagram of an electronic device according to an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are some, but not all embodiments of the present disclosure. All other embodiments, which can be derived by a person skilled in the art from the embodiments disclosed herein without creative labor, are intended to be within the scope of the present disclosure.

It should be noted that user information (including but not limited to user device information, user personal information, etc.) and data (including but not limited to data for analysis, data for storage, data for presentation, etc.) referred to in the present disclosure are information and data authorized by the user or fully authorized by each party, and the collection, use and processing of the related data need to comply with relevant laws and regulations and standards in relevant countries and regions, and are provided with corresponding operation entries for the user to select authorization or denial.

The following explains application scenarios of the embodiments of the present disclosure:

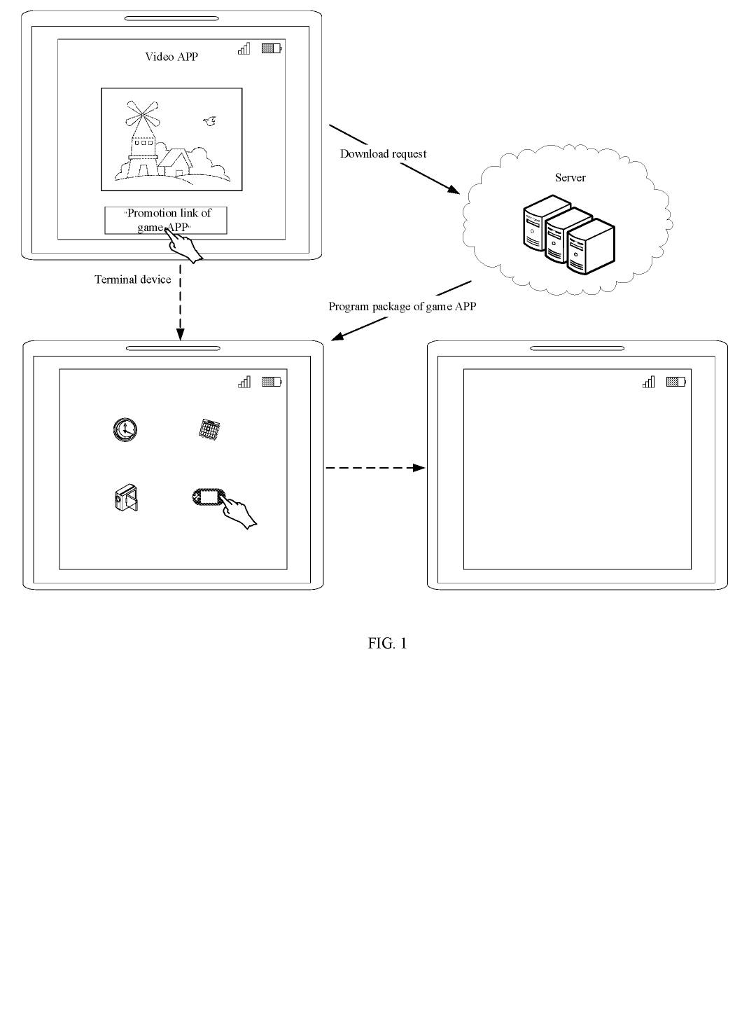

FIG. 1 is an application scenario diagram of an application fast loading method according to an embodiment of the present disclosure, and the application fast loading method according to the embodiment of the present disclosure may be applied to an application scenario of application downloading, and more specifically, may be applied to a scenario of downloading a third party application in a main application, where the main application includes, for example, a video application, a news information application, and the like. An execution subject of this embodiment may be a terminal device running the main application, a server deploying a server corresponding to the application, or other electronic devices having similar functions.

In some embodiments, a terminal device or server may implement the application fast loading method provided by the embodiments of the present application by running various computer-executable instructions or computer programs. For example, the computer-executable instructions may be program-level commands, machine instructions, or software instructions. The computer program may be a native program or a software module in an operating system; may be a local application, that is, a program that needs to be installed in an operating system to run, or an applet embedded in any APP, that is, a program that runs based on a browser environment. In summary, the computer-executable instructions may be instructions in any form, the computer program may be an application, a module or a plug-in in any form, and a specific implementation form may be configured as required. Further, in some embodiments, the server may be an independent physical server, may also be a server cluster or a distributed system formed by a plurality of physical servers, and may also be a cloud server that provides basic cloud computing services such as a cloud service, a cloud storage, a cloud communication, a cloud database, cloud computing, a cloud function, a web service, a middleware service, a domain name service, a security service, a Content Delivery Network (CDN), and a big data and artificial intelligence platform, where the cloud service may be an interaction processing service for a terminal device to call.

Referring to FIG. 1, in case where the terminal device is an execution subject, a video APP (main application) is installed on the terminal device, a user, when using the video APP, browses a promotion link of a game APP promoted by a game developer, based on that the user clicks the promotion link, the terminal device sends a download request for obtaining the game APP to a server by the method provided by this embodiment, a bootstrap program corresponding to the game APP and a package of the game APP are downloaded from the server, and then the terminal device runs the bootstrap program by the method provided by this embodiment to start the game APP, and then the terminal device displays a running screen of the game APP, where application icons of "clock", "calendar" and "camera" are displayed on a system desktop of the terminal device, after the game APP is installed on the terminal device, an application icon of "game APP" is also displayed. It is to be understood, of course, that in another possible implementation, the execution subject of the method provided in this embodiment may also be a server, that is, the processing process is all executed by the server, and only those interacting with the user are implemented by the terminal device, and then the terminal device sends user operation information corresponding to the user interaction to one side of the server for processing, and models and algorithms used in the server execution process may be all deployed in the server, or partially deployed in the server, or partially deployed in other servers and called by the servers, and the specific implementation process is similar, and is not described herein again.

In the related art, after the user clicks the promotion link of the game APP issued by the developer, the terminal device downloads the program package of the game APP through a browser, and after the program package is downloaded, the installation of the game APP is triggered based on the program package, and after the installation of the game APP is finished, the user operates the game APP by clicking an APP icon and the like. In the process, the user needs to wait for a long time for the terminal device to download the program package of the game APP to the local and install the program package, and then further applies a starting operation, to enable the game APP to run, resulting in low application loading speed and complex interaction process.

The embodiment of the present disclosure provides an application fast loading method to solve the above problem.

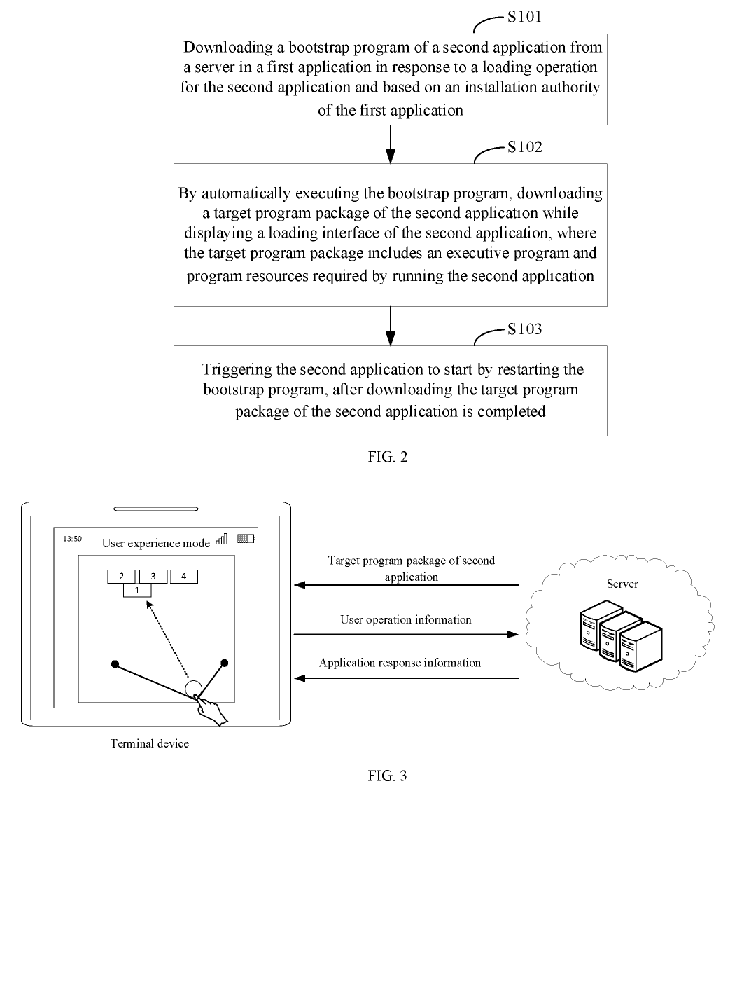

Referring to FIG. 2, FIG. 2 is a first flow diagram of an application fast loading method according to an embodiment of the present disclosure. The method of the embodiment can be applied to a server, terminal device or other electronic device, and includes:

step S101: downloading a bootstrap program of a second application from a server in a first application in response to a loading operation for the second application and based on an installation authority of the first application.

Referring to the application scenario diagram shown in FIG. 1, in this embodiment, the terminal device is taken as an execution subject to introduce the provided application fast loading method, for example, a first application corresponds to the video APP shown in FIG. 1, a second application corresponds to the game APP shown in FIG. 1, a server corresponds to the server shown in FIG. 1, the first application is already installed in the terminal device, and a program package of a bootstrap program of the second application and a target program package of the second application are stored in the server; when a user uses the first application through terminal device, the first application displays promotion information of the second application to the user through the terminal device, i.e., a promotion link of the second application released by the developer of the second application; the terminal device, based on the user clicking promotion information of the second application displayed in the first application, obtains a loading operation for the second application by the terminal device in the first application, and then the terminal device downloads the program package of the bootstrap program of the second application from the server based on an installation authority of the first application, i.e., download the bootstrap program of the second application from the server; and then after the terminal device finishes downloading the program package of the bootstrap program from the server, the bootstrap program can be deployed in the local of the terminal device based on the program package of the bootstrap program, where the installation authority of the first application is that the operating system of the terminal device allows the terminal device to download the program package of the application through the first application, and installation and deployment of the corresponding application are carried out.

Step S102: by automatically executing the bootstrap program, downloading a target program package of the second application while displaying a loading interface of the second application, where the target program package includes an executive program and program resources required by running the second application.

Illustratively, after the bootstrap program is installed on the terminal device, the bootstrap program may be automatically executed on the terminal device, so as to display a loading interface of the second application on a display interface of the terminal device, and at the same time, in a background process of the terminal device, the terminal device is simultaneously enabled to download a target program package of the second application from the server, where, the target program package includes an executive program and program resources required by the second application, the executive program is used for running of the second application on the terminal device, and the program resources include text resources, image resources, audio resources, and video resources required by the second application when running.

Further, at least one of the following is displayed within the loading interface: use direction of the second application, version update content of the second application, promotion content of the second application and download progress of the target program package; specifically, for example, the loading interface displays promotion content of the second application and download progress of the target program package, displaying the promotion content of the second application to the user to improve promotion efficiency, and displaying the download progress of the target program package to the user to enable the user to estimate time for the terminal device to finish downloading the target program package, and using the terminal device to perform other operations based on the estimated time. Based on the display content of the loading interface displayed to the user by the terminal device, the use experience of the user in the process of waiting for the terminal device to download the target program package of the second application is improved.

In a possible implementation, FIG. 3 is a schematic diagram of an operation process of a terminal device when the terminal device automatically executes based on a bootstrap program, according to an embodiment of the present disclosure; as shown in FIG. 3, after the terminal device downloads and installs the bootstrap program from the server, the terminal device automatically executes based on the bootstrap program, and may display a loading interface of the second application, and at the same time, the terminal device downloads a target program package of the second application from the server; in the process of downloading the target program package of the second application, the terminal device, in response to an operation of the user on the loading interface of the second application, sends user operation information to the server, the server returns response information to the terminal device based on the user operation information, and then the user performs further operation based on the response information; specifically, for example, in a process of downloading the target program package by the terminal device, the loading interface displayed by the terminal device is a user experience mode of the second application, the terminal device generates user operation information based on an operation of the user in the user experience mode, the server receives the user operation information sent by the terminal device and generates corresponding application response information based on the user operation information, and the terminal device receives the application response information and updates a process of the user experience mode based on the application response information, so that the user performs further operations; for example, the user experience mode shown in FIG. 3 is specifically: in a pinball game, a user ejects a pinball (a hollow circle shown in FIG. 3) to a brick (a rectangular frame with a mark shown in FIG. 3) above a terminal device through an elastic rope (a black solid line shown in FIG. 3, where the elastic rope is in a pull-down power accumulation state in response to a swipe operation of the user) below the terminal device,, and then knocks down bricks with marks 1, 2, 3 and 4, and as shown in FIG. 3, the pinball moves in a direction indicated by a dotted line based on the power accumulation state of the elastic rope in response to the operation of the user, and when the pinball touches the brick No. 1, the brick No. 1 can be knocked down.

Further, in a possible implementation, the display information of the loading interface displayed by the terminal device to the user and the corresponding information amount are decided by at least the speed of downloading the target program package by the terminal device and the size of the target program package, and more specifically, for example, according to the speed of downloading the target program package and the size of the target program package, a target estimated time length for completing downloading the target program package is obtained; and further, the display information of the loading interface and the corresponding information amount are determined according to the target estimated time length. Specifically, for example, the second application is a game APP, when the terminal device device_1 downloads the game APP, a target estimated time length time_1 is obtained; if the target estimated time length time _1 is less than a preset reference time length, the display information of the loading interface is the use direction and download progress of the game APP, and if the target estimated time length time _1 is greater than or equal to the preset reference time length, the display information of the loading interface is the user experience mode of the game APP, that is, a user can experience the game APP in the user experience mode.

In the steps of the embodiment of the present disclosure, based on the target estimated time length corresponding to the target program package, the terminal device determines the corresponding display information by operating the bootstrap program and/or requesting the server, that is, if the target estimated time length is short, the display information is simple, and if the target estimated time length is long, the display information is rich, so that the display information matched with the target estimated time length is displayed to the user on the loading interface, thereby improving the user experience when the second application is downloaded.

Step S103: triggering the second application to start by restarting the bootstrap program, after downloading of the target program package of the second application is completed.

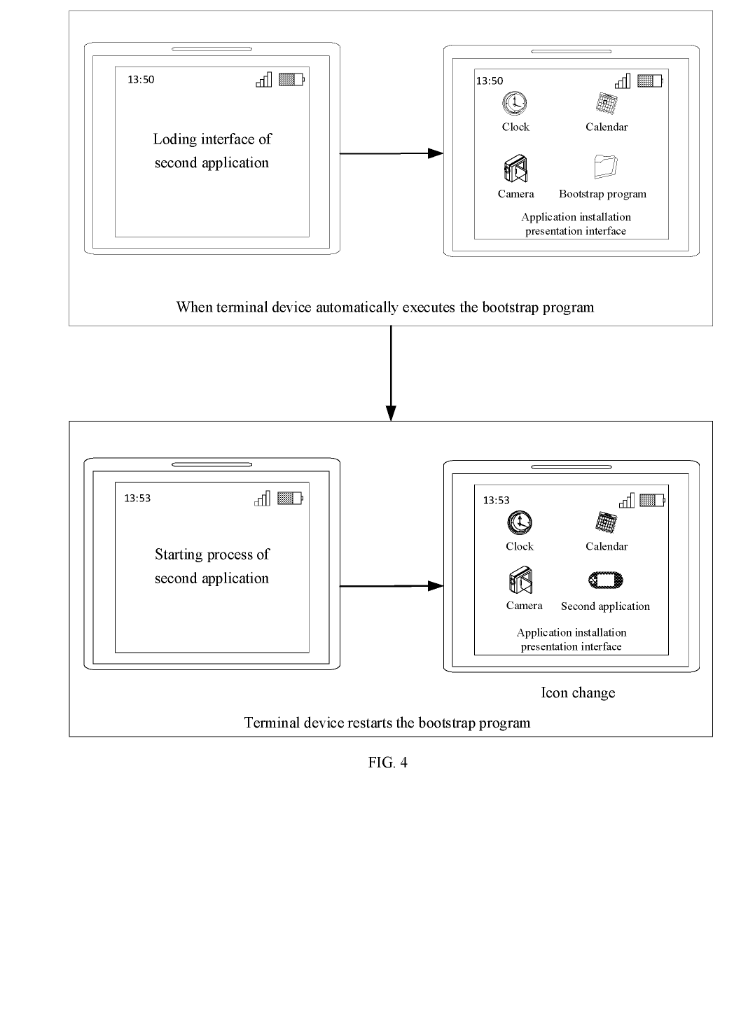

Illustratively, after the terminal device finishes downloading the target program package of the second application from the server, the terminal device may trigger the second application to start by restarting the bootstrap program. Specifically, in a possible implementation, FIG. 4 is a schematic display diagram of a display interface of a terminal device corresponding to a second application fast loading process, according to an embodiment of the present disclosure; as shown in FIG. 4, when the terminal device automatically executes the bootstrap program, the display interface of the terminal device displays the loading interface of the second application; if the user returns to an application installation presentation interface (for example, system desktop of the mobile phone, system desktop of the tablet) of the terminal device from the loading interface, the application installation presentation interface (at this time, the application installation presentation interface is the display interface) displays an application icon of the bootstrap program, where the application installation presentation interface also displays application icons such as "clock", "calendar" and "camera"; it will be appreciated that, in another implementation, the application installation presentation interface does not display the application icons of the bootstrap program; furthermore, after the terminal device finishes downloading the target program package of the second application from the server, the terminal device restarts the bootstrap program; if the display interface of the terminal device is the loading interface of the second application, the second application is directly started after the operation data of the user on the current loading interface is backed up, that is, the display interface is the starting process of the second application, and the operation data backed up by the terminal device is, for example, user operation information generated by the terminal device based on the operation of the user in the user experience mode; if the display interface of the terminal device is the application installation presentation interface, the display interface is skipped and displayed as the starting process of the second application; and simultaneously, when the second application starts to be started, or in the starting process, or after the second application is started, the application icon of the bootstrap program displayed on the application installation presentation interface is changed into the application icon of the second application.

Further, in another possible implementation, after downloading of the target program package of the second application is completed, restart prompt information is displayed on the loading interface of the second application, where the restart prompt information is used to guide a user to apply a restart operation for the bootstrap program; triggering the second application to start by restarting the bootstrap program, including: after receiving the restart operation for the bootstrap program, restarting the bootstrap program to start the second application. More specifically, for example, based on that the terminal device finishes downloading the target program package of the second application from the server, the bootstrap generates corresponding restart prompt information, and displays the restart prompt information on the loading interface of the second application, so as to guide the user to apply a restart operation for the bootstrap program, where for example, the restart prompt information is "please click Confirm button to restart the bootstrap program, so as to directly load the second application"; furthermore, the terminal device restarts the bootstrap program based on the restart operation applied by the user for the bootstrap program, so as to start the second application, and provide service for the user based on the application function of the second application, that is, finish fast loading of the second application.

Further, in step S102, when the terminal device automatically executes the bootstrap program, after the bootstrap program is started, the terminal device detects whether the target program package is stored locally in the terminal device, and downloads the target program package of the second application from the server based on a detection result, or starts the second application. Specifically, after the bootstrap program is started, detecting whether the target program package of the second application exists locally or not to obtain a detection result; if the target program package does not exist locally according to the detection result, downloading the target program package of the second application while displaying the loading interface of the second application; and if the target program package exists locally according to the detection result, starting the second application based on the target program package. In a possible implementation, in the step S102, when the terminal device automatically executes the bootstrap program, the terminal device detects whether the target program package of the second application exists locally, and obtains a detection result; if the target program package does not exist locally according to the detection result, the terminal device continues to execute the step S102, that is, the target program package of the second application is downloaded while the loading interface of the second application is displayed; if the target program package exists locally according to the detection result, the terminal device directly executes the step S103, that is, the terminal device does not continue to execute the process of "downloading a target program package of the second application while displaying a loading interface of the second application" in the step S102, and directly starts the second application based on the target program package.

The embodiment involves: downloading a bootstrap program of a second application from a server in a first application in response to a loading operation for the second application and based on an installation authority of the first application; by automatically executing the bootstrap program, downloading a target program package of the second application while displaying a loading interface of the second application, where the target program package includes an executive program and program resources required by running the second application; and triggering the second application to start by restarting the bootstrap program, after downloading of the target program package of the second application is completed. By downloading, in the first application, the bootstrap program of the second application using the installation authority of the first application, then using the bootstrap program, on one hand, the loading interface of the second application is displayed, and on the other hand, the target program package required by running the second application is downloaded based on the bootstrap program, and the bootstrap program is restarted to automatically start the second application after the target program package is downloaded, solving the problems of low application loading speed and complex interaction process.

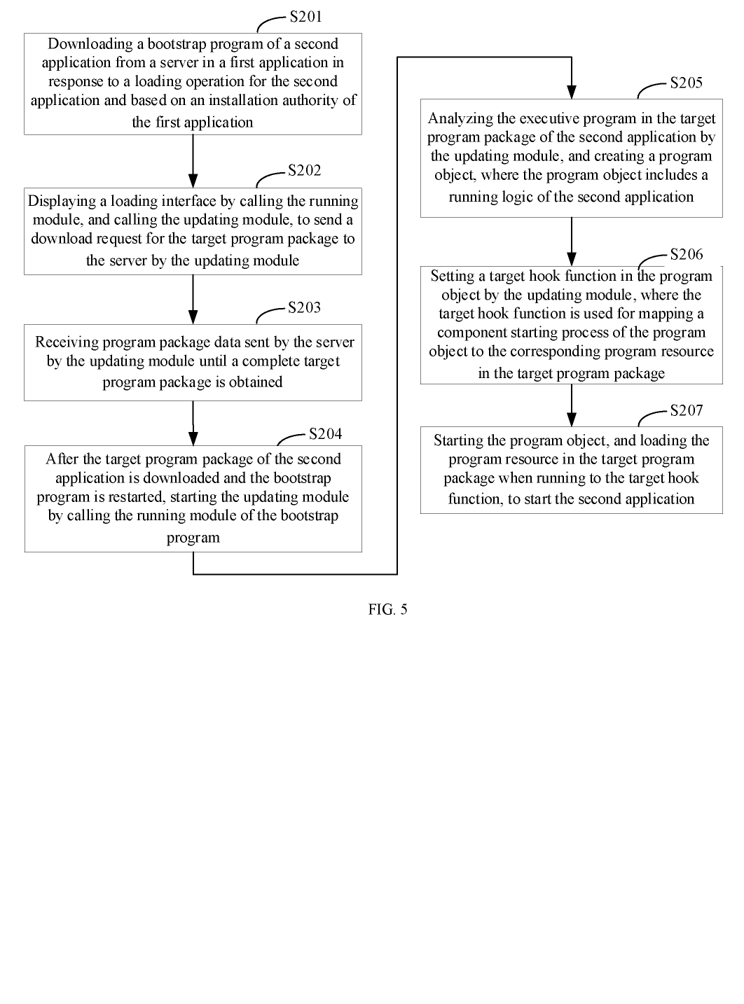

Referring to FIG. 5, FIG. 5 is a second schematic flow diagram of an application fast loading method according to an embodiment of the present disclosure. On the basis of the embodiment shown in FIG. 2, this embodiment further refines the step S102 and step S103, the bootstrap program includes a running module and an updating module, and the application fast loading method includes:

step S201: downloading a bootstrap program of a second application from a server in a first application in response to a loading operation for the second application and based on an installation authority of the first application;

step S202: displaying a loading interface by calling the running module, and calling the updating module, to send a download request for the target program package to the server by the updating module;

step S203: receiving program package data sent by the server by the updating module until a complete target program package is obtained.

Illustratively, the bootstrap program includes a running module and an updating module; when the bootstrap program is automatically executed, by calling the running module and the updating module, the terminal device downloads the target program package of the second application from the server while displaying the loading interface of the second application; and further, after the complete target program package is obtained, sends a download completion message of the target program package of the second application to the running module by the updating module, where the download completion message is used for triggering the restart of the bootstrap program.

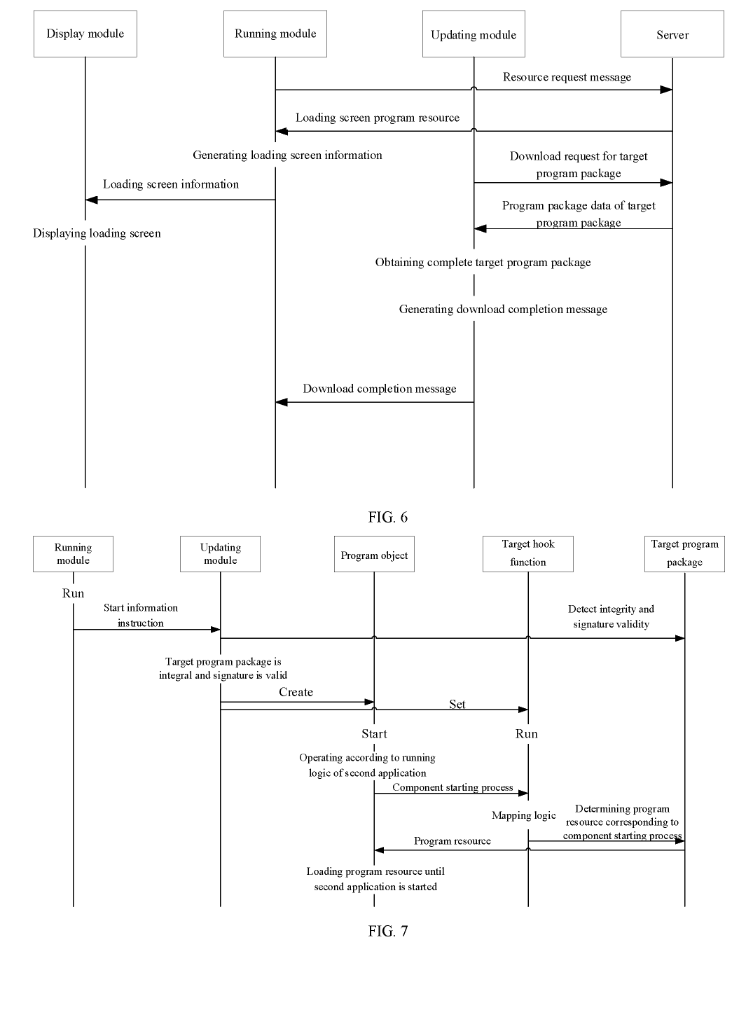

In a possible implementation, FIG. 6 is a schematic diagram of signaling interaction based on calling a running module and an updating module, according to an embodiment of the present disclosure; as shown in FIG. 6, the terminal device obtains, by calling the running module, a loading screen program resource corresponding to a loading screen of the second application from the server or a storage module of the terminal device, for example, if the loading screen program resource is obtained from the server, the running module sends resource request information for loading the screen program resource to the server, the server sends the loading screen program resource to the running module of the terminal device based on the received resource request information, the running module generates loading screen information based on the loading screen program resource, the display module of the terminal device displays a loading screen based on the loading screen information, the loading screen program resource obtained from the server can correspond to the user experience mode of the second application; meanwhile, the terminal device sends a download request for the target program package to the server by calling the updating module, the server sends program package data of the target program package to the updating module of the terminal device based on the download request for the target program package, and then the terminal device receives the program package data sent by the server by the updating module until the complete target program package is obtained; further, after the complete target program package is obtained, the updating module generates a download completion message of the target program package of the second application, and further sends the download completion message to the running module, to trigger the restart of the bootstrap program.

Further, in another possible implementation, the automatic execution process of the bootstrap program is implemented by the terminal device by calling at least two processes, and in this case, the specific implementation of steps S202 and S203 includes:

step S2000: acquiring a corresponding first process and a corresponding second process by automatically executing the bootstrap program;

step S202A: displaying the loading interface by calling the running module through a first process, and sending the download request for the target program package to the server by calling the updating module through the first process;

step S203A: continuously receiving the program package data sent by the server by calling the updating module through the second process, until the complete target program package is obtained.

Exemplarily, when the bootstrap program is automatically executed, the terminal device obtains a first process and a second process of the bootstrap program, and then the terminal device displays the loading interface by calling the running module through the first process, and calls the updating module to send a download request for the target program package to the server, where, the terminal device calls the running module and the updating module through the first process, where the calling may be asynchronous calling, for example, firstly calling the running module, then calling the updating module, or may be synchronous calling, that is, calling the running module and the updating module at the same time; illustratively, the first process includes at least a first thread and a second thread, the first thread is used for calling the running module, the second thread is used for calling the updating module, and further, when the terminal device calls the running module and the updating module through the first process, the first thread may be executed prior to the second thread, and the first thread may also be executed simultaneously with the second thread. Further, after the terminal device calls the updating module through the first process to send a download request for the target program package to the server, the terminal device calls the updating module through the second process so that the updating module continuously receives the program package data of the target program package sent by the server until the complete target program package is obtained.

Step S204: after downloading of the target program package of the second application is completed and the bootstrap program is restarted, starting the updating module by calling the running module of the bootstrap program.

Step S205: analyzing the executive program in the target program package of the second application by the updating module, and creating a program object, where the program object includes a running logic of the second application.

Exemplarily, after the bootstrap program is restarted, the terminal device starts the updating module by calling the running module of the bootstrap program; and then the updating module carries out integrity detection and signature validity detection on the target program package of the downloaded second application, after the target program package is confirmed to be integral and signature-valid, the updating module analyzes an executive program in the target program package, and creates a program object of the second application so as to start and run the second application, where the program object includes running logic of the second application.

Step S206: setting a target hook function in the program object by the updating module, where the target hook function is used for mapping a component starting process of the program object to the corresponding program resource in the target program package.

Step S207: starting the program object, and loading the program resource in the target program package when running the target hook function, to start the second application.

Exemplarily, when the target hook function runs, it is able to, when the second application is started, map a component starting process of the program object corresponding to the second application to the corresponding program resource in the target program package, that is, determining the program resource in the target program package that needs to be called by the component starting process. Furthermore, after the updating module creates the program object of the second application, the terminal device sets the target hook function in the program object by calling the updating module, so as to add a mapping logic for directly calling a corresponding program resource in the target program package based on the component starting process, in the running logic of the second application.

Further, after the terminal device starts the program object of the second application, the program object runs according to the running logic of the second application, and runs the target hook function; when the program object is executed to the component starting process, the target hook function determines the corresponding program resource in the target program package based on the mapping logic corresponding to the component starting process, and then the program object loads the program resource according to the running logic of the second application, thereby starting the second application. Specifically, for example, the component starting process includes a component starting process proc_1 and a component starting process proc_2, the program resources include a program resource reso_1, a program resource reso_2 and a program resource reso_3, the component starting process proc_1 is mapped corresponding to the program resource reso_1, and the component starting process proc_2 is mapped corresponding to the program resource reso_2; exemplarily, the target hook function determines the corresponding program resource reso_1 from the target program package according to the mapping logic corresponding to the component starting process proc_1, and then the program object loads the program resource reso_1 according to the running logic of the second application; and the target hook function determines the corresponding program resource reso_2 from the target program package according to the mapping logic corresponding to the component starting process proc_2, and then the program object loads the program resource reso_2 according to the running logic of the second application.

In a possible implementation, the second application is a game application, after the program object of the game application is started, the program object starts to run based on the running logic of the game application, the target hook function runs synchronously, and then when the program object starts four component starting processes corresponding to four game components based on the running logic, the target hook function directly determines the corresponding program resources from the target program package based on the four component starting processes, according to the mapping logic between the component starting processes and the corresponding program resources in the target program package; and then the program object continues to run according to the running logic based on the program resource determined by the target hook function, until the second application is started, where the four game components include: Activity component, Service component, BroadcastReceiver component, ContentProvider component.

FIG. 7 is a schematic diagram of signaling interaction when a second application is started according to an embodiment of the present disclosure; as shown in FIG. 7, after a target program package of the second application is downloaded, the terminal device restarts the bootstrap, that is, a running module of the bootstrap starts to run, and sends a start information instruction for starting the second application to an updating module of the bootstrap program, and after the updating module receives the start information instruction, the updating module detects integrity and signature validity of the target program package, and after the target program package is integral and signature-valid, creates a program object of the second application according to an executive program in the target program package, and sets a target hook function; and then starts the program object, and operates the target hook function; in the process that the program object operates according to the running logic of the second application, when the program object is executed to the component starting process, the target hook function determines the program resource corresponding to the component starting process in the target program package, according to the mapping logic between the component starting process and the corresponding program resource in the target program package, and further the program object loads the program resource according to the running logic of the second application until the second application is started.

In this embodiment, in the process that the program object operates according to the running logic of the second application, by the set target hook function, the program resource mapped correspondingly by the component starting process of the program object in the target program package is determined, so that the program object completes starting of the second application according to the program resource, avoiding complex logic triggered in the execution of the component starting process, realizing fast loading and starting of the second application, and solving the problems of low application loading speed and complex interaction process.

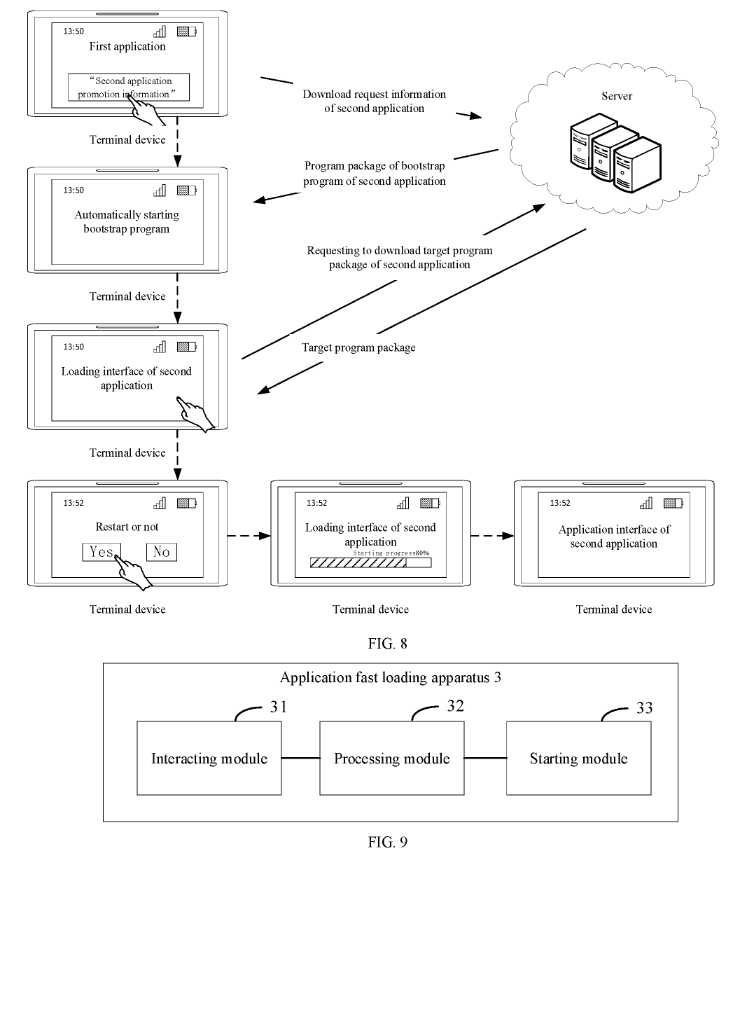

FIG. 8 is a schematic diagram of a process of fast loading a second application according to an embodiment of the present disclosure, which is described in more detail with reference to FIG. 8 below, and as shown in FIG. 8, a terminal device sends, to a server, download request information of the second application based on a click operation of a user on promotion information of the second application displayed in a first application during a use process of the first application, and then the server sends a program package of a bootstrap program of the second application to the terminal device; then the terminal device automatically installs the bootstrap program based on an installation authority of the first application, and automatically starts the bootstrap program after the installation of the bootstrap program is finished; the terminal device calls a running module based on a first process, a display interface of the terminal device displays a loading interface of the second application, meanwhile calls an updating module to request the server to download the target program package of the second application, and the terminal device continuously receives the target program package sent by the server by calling the updating module based on a second process; furthermore, after the target program package is downloaded, the updating module generates a download completion message and sends the download completion message to the running module, the running module generates restart prompt information of the bootstrap program (for example, whether the bootstrap program is restarted immediately or not, whether the corresponding option is yes or no) based on the download completion message, the restart prompt information is displayed on a display interface of the terminal device, then the terminal device restarts the bootstrap program based on the option 'yes' selected by the user, and if the user selects 'no', the user waits for the next initiative start of the bootstrap program; after the bootstrap program is restarted, the display interface of the terminal device displays a start interface of the second application, where content displayed by the start interface includes a start progress, and a display style of the start progress is, for example, a progress bar, such as "start progress 80%" shown in FIG. 8; meanwhile, in the background process of the terminal device, after the bootstrap program is restarted, the running module of the bootstrap program starts to execute, meanwhile, an updating module is started based on the running module, the started updating module creates a program object of the second application based on an executive program in the target program package and sets a target hook function, and then the program object operates according to the running logic of the second application and operates the target hook function, when the program object is executed to the component starting process, the target hook function maps the component starting process to the corresponding program resource in the target program package so as to determine the corresponding program resource in the target program package, and the program object loads the program resource to realize fast loading of the second application, and further, when realizing fast loading of the second application, the display interface of the terminal device displays the application interface of the second application.

In this embodiment, the implementation of the step S201 is the same as that of the step 101 in the embodiment shown in FIG. 2 of the present disclosure, and is not described in detail here.

FIG. 9 is a block diagram of an application fast loading apparatus according to an embodiment of the present disclosure, which corresponds to the application fast loading method according to the foregoing embodiment. The method described in the foregoing embodiment may be executed by the application fast loading apparatus, and the apparatus may be implemented by software and/or hardware, and may be integrated in an electronic device with certain data processing function. The electronic device may include, but is not limited to, a mobile terminal with a large data processing capability, and a fixed terminal with a large data processing capability, such as a desktop computer and a super computer.

For ease of illustration, only portions relevant to the embodiments of the present disclosure are shown. Referring to FIG. 9, the application fast loading apparatus 3 includes:

an interacting unit 31 configured to, download a bootstrap program of a second application from a server in a first application in response to a loading operation for the second application and based on an installation authority of the first application;

a processing unit 32 configured to, by automatically executing the bootstrap program, download a target program package of the second application while displaying a loading interface of the second application, where the target program package includes an executive program and program resources required by running the second application; and

a starting unit 33 configured to, trigger the second application to start by restarting the bootstrap program, after downloading of the target program package of the second application is completed.

According to one or more embodiments of the present disclosure, the bootstrap program includes a running module and an updating module, and the processing unit 32, when downloading a target program package of the second application while displaying a loading interface of the second application by automatically executing the bootstrap program, is specifically configured to: display the loading interface by calling the running module, and call the updating module, to send a download request for the target program package to the server by the updating module; and receive program package data sent by the server by the updating module until a complete target program package is obtained.

According to one or more embodiments of the present disclosure, after the complete target program package is obtained, the processing unit 32 is further configured to: send a download completion message of the target program package of the second application to the running module by the updating module, where the download completion message is used for triggering restart of the bootstrap program.

According to one or more embodiments of the present disclosure, the processing unit 32 is further configured to: obtain a corresponding first process and a corresponding second process by automatically executing the bootstrap program; the processing unit 32, when displaying the loading interface by calling the running module, and calling the updating module, is specifically configured to: display the loading interface by calling the running module through a first process, and send a download request for the target program package to the server by calling the updating module through the first process; the processing unit 32, when receiving the program package data sent by the server by the updating module until a complete target program package is obtained, is specifically configured to: continuously receive the program package data sent by the server by calling the updating module through the second process, until the complete target program package is obtained.

According to one or more embodiments of the present disclosure, the starting unit 33, when triggering the second application to start by restarting the bootstrap program, is specifically configured to: after the bootstrap program is restarted, start the updating module by calling the running module of the bootstrap program; analyze the executive program in the target program package of the second application by the updating module, and create a program object, where the program object includes a running logic of the second application; set a target hook function in the program object by the updating module, where the target hook function is used for mapping a component starting process of the program object to a corresponding program resource in the target program package; and start the program object, and load the program resource in the target program package when running the target hook function to start the second application.

According to one or more embodiments of the present disclosure, after the bootstrap program is started, the processing unit 32 is further configured to: detect whether the target program package of the second application exists locally to obtain a detection result; the processing unit 32, when downloading a target program package of the second application while displaying a loading interface of the second application, by automatically executing the bootstrap program, is specifically configured to: if the target program package does not exist locally according to the detection result, download the target program package of the second application while displaying the loading interface of the second application; the starting unit 33, when triggering the second application to start, is specifically configured to: if the target program package exists locally according to the detection result, start the second application based on the target program package.

According to one or more embodiments of the present disclosure, the starting unit 33 is further configured to: after downloading of the target program package of the second application is completed, display restart prompt information on the loading interface of the second application, where the restart prompt information is used for guiding a user to apply a restart operation for the bootstrap program; the starting unit 33, when triggering the second application to start by restarting the bootstrap program, is specifically configured to: after receiving the restart operation for the bootstrap program, restart the bootstrap program to start the second application.

According to one or more embodiments of the present disclosure, at least one of the following is displayed within the loading interface: use direction of the second application, version updating content of the second application, promotion content of the second application, or download progress of the target program package.

The interacting module 31, the processing module 32 and the starting module 33 are connected in sequence. The application fast loading apparatus 3 provided in this embodiment may execute the technical solution of the foregoing method embodiment, and the implementation principle and technical effect are similar, which are not described herein again.

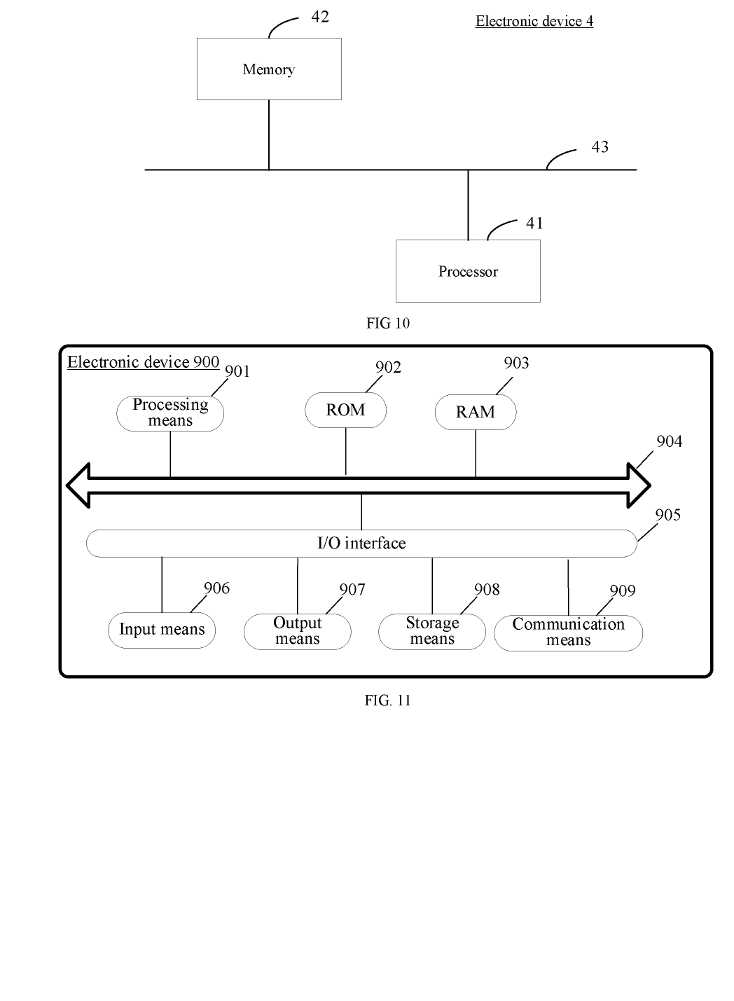

FIG. 10 is a schematic structural diagram of an electronic device according to an embodiment of the present disclosure, and as shown in FIG. 10, the electronic device 4 includes:

a processor 41, and a memory 42 communicatively coupled to the processor 41; where

the memory 42 stores computer-executable instructions;

the processor 41 executes the computer-executable instructions stored by the memory 42, to implement the application fast loading method in the embodiments shown in FIGS. 2-8.

Optionally, the processor 41 and the memory 42 are connected by a bus 43.

The relevant description may be understood by referring to the relevant description and effect corresponding to the steps in the embodiments corresponding to FIGS. 2-8, and redundant description is not repeated here.

The embodiments of the present disclosure provide a computer-readable storage medium having stored therein computer-executable instructions which, when executed by a processor, implement the application fast loading method provided in any embodiment corresponding to FIGS. 2-8 of the present disclosure.

The embodiment of the present disclosure provides a computer program product including a computer program which, when executed by a processor, implements the application fast loading method provided in any embodiment corresponding to FIGS. 2-8 of the present disclosure.

In order to implement the above embodiments, an embodiment of the present disclosure further provides an electronic device.

Referring to FIG. 11, FIG. 11 is a hardware schematic diagram of an electronic device according to an embodiment of the present disclosure, which shows a schematic structural diagram of an electronic device 900 suitable for implementing the embodiment of the present disclosure, where the electronic device 900 may be a terminal device or a server. Among them, the terminal device may include, but is not limited to, a mobile terminal such as a mobile phone, a notebook computer, a digital broadcast receiver, a Personal Digital Assistant (PDA), a tablet computer (PAD), a Portable Multimedia Player (PMP), a car terminal (e.g., a car navigation terminal), etc., and a fixed terminal such as a digital TV, a desktop computer, etc. The electronic device shown in FIG. 11 is only an example, and should not bring any limitation to the functions and the use range of the embodiment of the present disclosure.

As shown in FIG. 11, the electronic device 900 may include a processing means (e.g., a central processing unit, a graphics processor, etc.) 901, which may perform various suitable actions and processes according to a program stored in a Read Only Memory (ROM) 902 or a program loaded from a storage means 908 into a Random Access Memory (RAM) 903. In the RAM 903, various programs and data necessary for the operation of the electronic device 900 are also stored. The processing means 901, ROM 902, and RAM 903 are connected to each other via a bus 904. An input/output (I/O) interface 905 is also connected to the bus 904.

Generally, the following means may be connected to the I/O interface 905: input means 906 including, for example, a touch screen, touch pad, keyboard, mouse, camera, microphone, accelerometer, gyroscope, and the like; an output means 907 including, for example, a Liquid Crystal Display (LCD), a speaker, a vibrator, and the like; the storage means 908 including, for example, magnetic tape, hard disk, etc.; and a communication means 909. The communication means 909 may allow the electronic device 900 to communicate with other devices wirelessly or by wire to exchange data. While FIG. 11 illustrates the electronic device 900 having various means, it is to be understood that not all illustrated means are required to be implemented or provided. More or fewer means may be alternatively implemented or provided.

In particular, the processes described above with reference to the flow diagrams may be implemented as computer software programs, according to embodiments of the present disclosure. For example, the embodiments of the present disclosure include a computer program product including a computer program embodied on a computer-readable medium, the computer program including program code for performing the method illustrated by the flow diagram. In such an embodiment, the computer program may be downloaded and installed from a network through the communication means 909, or installed from the storage means 908, or installed from the ROM 902. The computer program, when executed by the processing means 901, performs the above-described functions defined in the methods of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium that is not a computer readable storage medium and that can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

The computer readable medium may be embodied in the electronic device; or may be separate and not assembled into the electronic device.

The computer readable medium carries one or more programs which, when executed by the electronic device, cause the electronic device to perform the method shown in the above embodiments.

Computer program code for carrying out operations for aspects of the present disclosure may be written in any combination of one or more programming languages, including an object oriented programming language such as Java, Smalltalk, C + +, and conventional procedural programming languages, such as the "C" language or similar programming languages. The program code may execute entirely on the user's computer, partly on the user's computer, as a stand-alone software package, partly on the user's computer and partly on a remote computer or entirely on the remote computer or server. In the scenario where the remote computer is involved, the remote computer may be connected to the user's computer through any type of Network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of systems, methods and computer program products according to various embodiments of the present disclosure. In this regard, each block in the flow or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved. It will also be noted that each block of the block and/or flow diagram, and combinations of blocks in the block and/or flow diagram, can be implemented by special purpose hardware-based systems that perform the specified functions or actions, or combinations of special purpose hardware and computer instructions.

The units or modules described in the embodiments of the present disclosure may be implemented by software or hardware. A name of a unit or module does not in some way constitute a limitation on the unit itself.

The functions described herein above may be performed, at least in part, by one or more hardware logic components. For example, without limitation, exemplary types of hardware logic components that may be used include: field Programmable Gate Array (FPGA), Application Specific Integrated Circuit (ASIC), Application Specific Standard Product (ASSP), system on a chip (SOC), Complex Programmable Logic Device (CPLD), and the like.

In the context of this disclosure, the machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, according to one or more embodiments of the present disclosure, there is provided an application fast loading method, including: downloading a bootstrap program of a second application from a server in a first application in response to a loading operation for the second application and based on an installation authority of the first application; by automatically executing the bootstrap program, downloading a target program package of the second application while displaying a loading interface of the second application, where the target program package includes an executive program and program resources required by running the second application; and triggering the second application to start by restarting the bootstrap program, after downloading of the target program package of the second application is completed.

According to one or more embodiments of the present disclosure, the bootstrap program includes a running module and an updating module; the by automatically executing the bootstrap program, downloading a target program package of the second application while displaying a loading interface of the second application includes: displaying the loading interface by calling the running module, and calling the updating module, to send a download request for the target program package to a server by the updating module; and receiving program package data sent by the server by the updating module until the complete target program package is obtained.

According to one or more embodiments of the present disclosure, after the complete target program package is obtained, the method further includes: sending a download completion message of the target program package of the second application to the running module by the updating module, where the download completion message is used for triggering restart of the bootstrap program.

According to one or more embodiments of the present disclosure, the method further includes: obtaining a corresponding first process and a corresponding second process by automatically executing the bootstrap program; the displaying the loading interface by calling the running module, and calling the updating module, includes: displaying the loading interface by calling the running module through the first process, calling the updating module through the first process, and sending the download request for the target program package to the server; the receiving program package data sent by the server by the updating module until the complete target program package is obtained, includes: continuously receiving the program package data sent by the server by calling the updating module through the second process, until the complete target program package is obtained.

According to one or more embodiments of the present disclosure, the triggering the second application to start by restarting the bootstrap program, includes: after restarting the bootstrap program, starting the updating module by calling the running module of the bootstrap program; analyzing the executive program in the target program package of the second application by the updating module, and creating a program object, where the program object includes a running logic of the second application; setting a target hook function in the program object by the updating module, where the target hook function is used for mapping a component starting process of the program object to a corresponding program resource in the target program package; and starting the program object, and loading the program resource in the target program package when running the target hook function, to start the second application.

According to one or more embodiments of the present disclosure, after the bootstrap program is started, the method further includes: detecting whether the target program package of the second application exists locally to obtain a detection result; the by automatically executing the bootstrap program, downloading a target program package of the second application while displaying a loading interface of the second application includes: if the target program package does not exist locally according to the detection result, downloading the target program package of the second application while displaying the loading interface of the second application; and the triggering the second application to start, includes: if the target program package exists locally according to the detection result, starting the second application based on the target program package.

According to one or more embodiments of the present disclosure, the method further includes: after downloading of the target program package of the second application is completed, displaying restart prompt information on the loading interface of the second application, where the restart prompt information is used for guiding a user to apply a restart operation for the bootstrap program; the triggering the second application to start by restarting the bootstrap program, includes: restarting the bootstrap program after receiving the restart operation for the bootstrap program, to start the second application.

According to one or more embodiments of the present disclosure, at least one of the following is displayed within the loading interface: use direction of the second application, version updating content of the second application, promotion content of the second application, or download progress of the target program package.

In a second aspect, according to one or more embodiments of the present disclosure, there is provided an application fast loading apparatus, including:

an interacting unit configured to, download a bootstrap program of a second application from a server in a first application in response to a loading operation for the second application and based on an installation authority of the first application;

a processing unit configured to, by automatically executing the bootstrap program, download a target program package of the second application while displaying a loading interface of the second application, where the target program package includes an executive program and program resources required by running the second application;and

a starting unit configured to, trigger the second application to start by restarting the bootstrap program, after downloading of the target program package of the second application is completed.

According to one or more embodiments of the present disclosure, the bootstrap program includes a running module and an updating module; the processing unit, when downloading a target program package of the second application while displaying a loading interface of the second application by automatically executing the bootstrap program, is specifically configured to: display the loading interface by calling the running module, and call the updating module, to send a download request for the target program package to a server by the updating module; and receive program package data sent by the server by the updating module until the complete target program package is obtained.

According to one or more embodiments of the present disclosure, after the complete target program package is obtained, the processing unit is further specifically configured to: send a download completion message of the target program package of the second application to the running module by the updating module, where the download completion message is used for triggering restart of the bootstrap program.

According to one or more embodiments of the present disclosure, the processing unit is further specifically configured to: obtain a corresponding first process and a corresponding second process by automatically executing the bootstrap program; the processing unit, when displaying the loading interface by calling the running module, and calling the updating module, is specifically configured to: display the loading interface by calling the running module through the first process, call the updating module through the first process, and send the download request for the target program package to the server; the processing unit, when receiving program package data sent by the server by the updating module until the complete target program package is obtained, is specifically configured to: continuously receive the program package data sent by the server by calling the updating module through the second process, until the complete target program package is obtained.

According to one or more embodiments of the present disclosure, the starting unit, when triggering the second application to start by restarting the bootstrap program, is specifically configured to: after restarting the bootstrap program, start the updating module by calling the running module of the bootstrap program; analyze the executive program in the target program package of the second application by the updating module, and create a program object, where the program object includes a running logic of the second application; set a target hook function in the program object by the updating module, where the target hook function is used for mapping a component starting process of the program object to a corresponding program resource in the target program package; and start the program object, and load the program resource in the target program package when running the target hook function, to start the second application.

According to one or more embodiments of the present disclosure, after the bootstrap program is started, the processing unit is further specifically configured to: detect whether the target program package of the second application exists locally to obtain a detection result; the processing unit, when downloading a target program package of the second application while displaying a loading interface of the second application by automatically executing the bootstrap program, is specifically configured to: if the target program package does not exist locally according to the detection result, download the target program package of the second application while displaying the loading interface of the second application; and the starting unit, when triggering the second application to start, is specifically configured to: if the target program package exists locally according to the detection result, start the second application based on the target program package.

According to one or more embodiments of the present disclosure, the starting unit is further specifically configured to: after downloading of the target program package of the second application is completed, display restart prompt information on the loading interface of the second application, where the restart prompt information is used for guiding a user to apply a restart operation for the bootstrap program; the starting unit, when triggering the second application to start by restarting the bootstrap program, is specifically configured to: restart the bootstrap program after receiving the restart operation for the bootstrap program, to start the second application.

According to one or more embodiments of the present disclosure, at least one of the following is displayed within the loading interface: use direction of the second application, version updating content of the second application, promotion content of the second application, or download progress of the target program package.

In a third aspect, according to one or more embodiments of the present disclosure, there is provided an electronic device, including: at least one processor and a memory; where

the memory stores computer-executable instructions;

the at least one processor executes the computer-executable instructions stored by the memory, to cause the at least one processor to perform the application fast loading method as described above in the first aspect and in various possible designs of the first aspect.

In a fourth aspect, according to one or more embodiments of the present disclosure, there is provided a computer-readable storage medium having stored thereon computer-executable instructions, which when executed by a processor, implement the application fast loading method as described above in the first aspect and in various possible designs of the first aspect.

In a fifth aspect, according to one or more embodiments of the present disclosure, there is provided a computer program product including a computer program which, when executed by a processor, implements the application fast loading method as described above in the first aspect and in various possible designs of the first aspect.

The foregoing is illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. An application fast loading method, comprising:
downloading a bootstrap program of a second application from a server in a first application in response to a loading operation for the second application and based on an installation authority of the first application;
by automatically executing the bootstrap program, downloading a target program package of the second application while displaying a loading interface of the second application, wherein the target program package comprises an executive program and program resources required by running the second application; and
triggering the second application to start by restarting the bootstrap program, after downloading of the target program package of the second application is completed.

2. The method according to claim 1, wherein, the bootstrap program comprises a running module and an updating module; the by automatically executing the bootstrap program, downloading a target program package of the second application while displaying a loading interface of the second application comprises:
displaying the loading interface by calling the running module, and calling the updating module, to send a download request for the target program package to a server by the updating module; and
receiving program package data sent by the server by the updating module until the complete target program package is obtained.

3. The method according to claim 2, wherein after the complete target program package is obtained, the method further comprising:
sending a download completion message of the target program package of the second application to the running module by the updating module, wherein the download completion message is used for triggering restart of the bootstrap program.

4. The method according to claim 2, further comprising:
obtaining a corresponding first process and a corresponding second process by automatically executing the bootstrap program;
the displaying the loading interface by calling the running module, and calling the updating module, comprises:
displaying the loading interface by calling the running module through the first process, calling the updating module through the first process, and sending the download request for the target program package to the server;
the receiving program package data sent by the server by the updating module until the complete target program package is obtained, comprises:
continuously receiving the program package data sent by the server by calling the updating module through the second process, until the complete target program package is obtained.

5. The method according to claim 2, wherein, the triggering the second application to start by restarting the bootstrap program, comprises:
after restarting the bootstrap program, starting the updating module by calling the running module of the bootstrap program;
analyzing the executive program in the target program package of the second application by the updating module, and creating a program object, wherein the program object comprises a running logic of the second application;
setting a target hook function in the program object by the updating module, wherein the target hook function is used for mapping a component starting process of the program object to a corresponding program resource in the target program package; and
starting the program object, and loading the program resource in the target program package when running the target hook function, to start the second application.

6. The method according to claim 1, wherein after the bootstrap program is started, the method further comprises:
detecting whether the target program package of the second application exists locally to obtain a detection result;
the by automatically executing the bootstrap program, downloading a target program package of the second application while displaying a loading interface of the second application comprises:
in response to that the target program package does not exist locally according to the detection result, downloading the target program package of the second application while displaying the loading interface of the second application; and
the triggering the second application to start, comprises:
in response to that the target program package exists locally according to the detection result, starting the second application based on the target program package.

7. The method according to claim 1, further comprising:
after downloading of the target program package of the second application is completed, displaying restart prompt information on the loading interface of the second application, wherein the restart prompt information is used for guiding a user to apply a restart operation for the bootstrap program;
the triggering the second application to start by restarting the bootstrap program, comprises:
restarting the bootstrap program after receiving the restart operation for the bootstrap program, to start the second application.

8. The method according to claim 1, wherein, at least one of the following is displayed within the loading interface: use direction of the second application, version updating content of the second application, promotion content of the second application, or download progress of the target program package.

9. An electronic device, comprising: at least one processor and a memory; wherein
the memory stores computer-executable instructions;
the at least one processor executes the computer-executable instructions stored by the memory, to cause the at least one processor to perform an application fast loading method, comprising:
downloading a bootstrap program of a second application from a server in a first application in response to a loading operation for the second application and based on an installation authority of the first application;
by automatically executing the bootstrap program, downloading a target program package of the second application while displaying a loading interface of the second application, wherein the target program package comprises an executive program and program resources required by running the second application; and
triggering the second application to start by restarting the bootstrap program, after downloading of the target program package of the second application is completed.

10. The electronic device according to claim 9, wherein, the bootstrap program comprises a running module and an updating module; the by automatically executing the bootstrap program, downloading a target program package of the second application while displaying a loading interface of the second application comprises:
displaying the loading interface by calling the running module, and calling the updating module, to send a download request for the target program package to a server by the updating module; and
receiving program package data sent by the server by the updating module until the complete target program package is obtained.

11. The electronic device according to claim 10, wherein after the complete target program package is obtained, the method further comprising:
sending a download completion message of the target program package of the second application to the running module by the updating module, wherein the download completion message is used for triggering restart of the bootstrap program.

12. The electronic device according to claim 10, further comprising: obtaining a corresponding first process and a corresponding second process by automatically executing the bootstrap program;
the displaying the loading interface by calling the running module, and calling the updating module, comprises:
displaying the loading interface by calling the running module through the first process, calling the updating module through the first process, and sending the download request for the target program package to the server;
the receiving program package data sent by the server by the updating module until the complete target program package is obtained, comprises:
continuously receiving the program package data sent by the server by calling the updating module through the second process, until the complete target program package is obtained.

13. The electronic device according to claim 10, wherein, the triggering the second application to start by restarting the bootstrap program, comprises:
after restarting the bootstrap program, starting the updating module by calling the running module of the bootstrap program;
analyzing the executive program in the target program package of the second application by the updating module, and creating a program object, wherein the program object comprises a running logic of the second application;
setting a target hook function in the program object by the updating module, wherein the target hook function is used for mapping a component starting process of the program object to a corresponding program resource in the target program package; and
starting the program object, and loading the program resource in the target program package when running the target hook function, to start the second application.

14. The electronic device according to claim 9, wherein after the bootstrap program is started, the method further comprises:
detecting whether the target program package of the second application exists locally to obtain a detection result;
the by automatically executing the bootstrap program, downloading a target program package of the second application while displaying a loading interface of the second application comprises:
in response to that the target program package does not exist locally according to the detection result, downloading the target program package of the second application while displaying the loading interface of the second application; and
the triggering the second application to start, comprises:
in response to that the target program package exists locally according to the detection result, starting the second application based on the target program package.

15. The electronic device according to claim 9, further comprising:
after downloading of the target program package of the second application is completed, displaying restart prompt information on the loading interface of the second application, wherein the restart prompt information is used for guiding a user to apply a restart operation for the bootstrap program;
the triggering the second application to start by restarting the bootstrap program, comprises:
restarting the bootstrap program after receiving the restart operation for the bootstrap program, to start the second application.

16. The electronic device according to claim 9, wherein, at least one of the following is displayed within the loading interface: use direction of the second application, version updating content of the second application, promotion content of the second application, or download progress of the target program package.

17. A non-transitory computer-readable storage medium having stored thereon computer-executable instructions, which when executed by a processor, implement an application fast loading method, comprising:
downloading a bootstrap program of a second application from a server in a first application in response to a loading operation for the second application and based on an installation authority of the first application;
by automatically executing the bootstrap program, downloading a target program package of the second application while displaying a loading interface of the second application, wherein the target program package comprises an executive program and program resources required by running the second application; and
triggering the second application to start by restarting the bootstrap program, after downloading of the target program package of the second application is completed.

18. The non-transitory computer-readable storage medium of claim 17, wherein, the bootstrap program comprises a running module and an updating module; the by automatically executing the bootstrap program, downloading a target program package of the second application while displaying a loading interface of the second application comprises:
displaying the loading interface by calling the running module, and calling the updating module, to send a download request for the target program package to a server by the updating module; and
receiving program package data sent by the server by the updating module until the complete target program package is obtained.

19. The non-transitory computer-readable storage medium of claim 18, wherein after the complete target program package is obtained, the method further comprising:
sending a download completion message of the target program package of the second application to the running module by the updating module, wherein the download completion message is used for triggering restart of the bootstrap program.

20. The non-transitory computer-readable storage medium of claim 18, further comprising: obtaining a corresponding first process and a corresponding second process by automatically executing the bootstrap program;
the displaying the loading interface by calling the running module, and calling the updating module, comprises:
displaying the loading interface by calling the running module through the first process, calling the updating module through the first process, and sending the download request for the target program package to the server;
the receiving program package data sent by the server by the updating module until the complete target program package is obtained, comprises:
continuously receiving the program package data sent by the server by calling the updating module through the second process, until the complete target program package is obtained.
